(19) United States
(12) Patent Application Publication
(10) Pub. No.: US 2024/0248307 A1
(43) Pub. Date: Jul. 25, 2024

(54) HEAD-MOUNTED DISPLAY APPARATUS AND OPTICAL UNIT

(71) Applicant: SEIKO EPSON CORPORATION, Tokyo (JP)

(72) Inventor: Takashi TAKEDA, Suwa-Shi (JP)

(73) Assignee: SEIKO EPSON CORPORATION, Tokyo (JP)

(21) Appl. No.: 18/415,542

(22) Filed: Jan. 17, 2024

(30) Foreign Application Priority Data
Jan. 19, 2023 (JP) 2023-006825

(51) Int. Cl. G02B 27/01; G02B 26/08; G02B 26/10

(52) U.S. Cl. CPC G02B 27/0172; G02B 26/0816; G02B 26/10; G02B 2027/0178

(57) ABSTRACT

A head-mounted display apparatus includes: a first projection optical system that irradiates a first scattering region with image light, a second projection optical system that irradiates a second scattering region with the image light, a first polarizing member arranged at a face side of the scattering member and including a first polarizing region provided corresponding to the first scattering region and the second scattering region for restricting the image light scattered by the scattering member to a first polarization direction, a second polarizing member arranged at an external side of a position of the first polarizing member and including a second polarizing region for restricting the external light to a second polarization direction, and a polarization separation lens element arranged at a face side of the first polarizing member and having refractive power that selectively acts on polarized light of the image light.

The present application is based on, and claims priority from JP Application Serial Number 2023-006825, filed Jan. 19, 2023, the disclosure of which is hereby incorporated by reference herein in its entirety.

### BACKGROUND

### 1. Technical Field

The present disclosure relates to a head-mounted display apparatus and an optical unit that enable observation of a virtual image, and particularly to a head-mounted display apparatus of a see-through type that enables visual recognition of an external image.

### 2. Related Art

As a see-through type virtual image display device that enables visual recognition of an outside world, a virtual image display device is known that includes a liquid crystal panel including an image display region and a transparent display region formed surrounding the image display region, and a light-guiding plate that guides backlight incident from a light source on an end portion, and in which the light-guiding plate includes a light-emitting region that irradiates the image display region of the liquid crystal panel with the backlight, and a light-transmitting region that transmits ambient light (WO 2016/056298). The display device is configured such that ambient light reaches an observer from the light-transmitting region of the light-guiding plate and the transparent display region of the liquid crystal panel, and the ambient light is transmitted through the light-emitting region of the light-guiding plate and the image display region of the liquid crystal panel and reaches the observer during a period in which the image display region is not irradiated with the backlight. With such a configuration, see-through display in which image light and ambient light are superimposed on each other is achieved.

In the above-described device, processing such as formation of dots and application of a scattering material is performed on the light-emitting region of the light-guiding plate, and the ambient light passing through the image display region of the liquid crystal panel passes through the processed light-emitting region, so that see-through transmittance decreases in a vicinity of a center of a visual field corresponding to the image display region. In order to achieve see-through display with high see-through transmittance in the vicinity of the center of the visual field, an optical system or the like with high see-through transmittance is separately required, which leads to an increase in size. In addition, in the above-described device, it is not easy to display an image common to both eyes while bringing a liquid crystal panel close to both the eyes for miniaturization.

### SUMMARY

A head-mounted display apparatus in an aspect of the present disclosure includes: a scattering member including a first scattering region for scattering image light for a right eye and a second scattering region for scattering image light for a left eye, a first projection optical system configured to irradiate the first scattering region with the image light, a second projection optical system configured to irradiate the second scattering region with the image light, a light-blocking member arranged at an external side of the scattering member and configured to suppress incidence of external light on the first scattering region and the second scattering region, a first polarizing member arranged at a face side of the scattering member and including a first polarizing region provided corresponding to the first scattering region and the second scattering region, the first polarizing region being configured to restrict the image light scattered by the scattering member to a first polarization direction, a second polarizing member arranged at an external side of a position of the first polarizing member and including a second polarizing region configured to restrict the external light to a second polarization direction different from the first polarization direction, and a polarization separation lens element arranged at a face side of the first polarizing member and having refractive power configured to selectively act on polarized light of the image light.

### BRIEF DESCRIPTION OF THE DRAWINGS

FIG. 1 is an external perspective view for explaining a mounted state of a head-mounted display apparatus of a first embodiment.

FIG. 2 is a conceptual plan view for describing an optical structure of the head-mounted display apparatus.

FIG. 3 is a conceptual perspective view for describing an optical structure of a display optical system.

FIG. 4 is a conceptual side view for describing the optical structure of the display optical system.

FIG. 5 is a conceptual enlarged perspective view for describing a repetition unit or a sub-pixel of a composite display member.

FIG. 6A is a plan view for describing a light-blocking member.

FIG. 6B is a plan view for describing a scattering member.

FIG. 6C is a plan view for describing a pattern polarizing member.

FIG. 7 is a diagram for describing an example of an irradiation state of a sub-pixel spot in a pixel section.

FIG. 8 is an enlarged conceptual diagram for describing a first scattering region and a second scattering region.

FIG. 9A is a diagram illustrating the light-blocking member, the scattering member and the pattern polarizing member in an overlapping manner.

FIG. 9B is a diagram in which the scattering member and the like are illustrated in an overlapping manner in a common observation region.

FIG. 10 is a conceptual diagram for describing a projection optical system.

FIG. 11 is a diagram for describing a pixel or a sub-pixel formed by the projection optical system.

FIG. 12 is a conceptual perspective view for describing a structure and a function of a polarization separation lens element.

FIG. 13A is a conceptual diagram for describing operation of the head-mounted display apparatus with respect to one eye.

FIG. 13B is a conceptual diagram for describing the operation of the head-mounted display apparatus with respect to the one eye.

FIG. 14 is a diagram for describing operation of a portion common to both eyes in the head-mounted display apparatus.

FIG. 15 is a conceptual diagram for describing a head-mounted display apparatus of a second embodiment.

FIG. 16A is a conceptual diagram for describing a head-mounted display apparatus of a third embodiment.

FIG. 16B is a plan view for describing a pattern polarizing member of the third embodiment.

FIG. 17A is a conceptual diagram for describing a head-mounted display apparatus of a fourth embodiment.

FIG. 17B is a conceptual diagram for describing a modification example of the head-mounted display apparatus of the fourth embodiment.

FIG. 18 is a conceptual diagram for describing a head-mounted display apparatus of a fifth embodiment.

FIG. 19 illustrates an example of a specific structure of a composite display member of the fifth embodiment.

FIG. 20 is a diagram for describing operation of a portion common to both the eyes in the head-mounted display apparatus.

FIG. 21 is a conceptual diagram for describing a composite display member of a sixth embodiment.

### DESCRIPTION OF EMBODIMENTS

### First Embodiment

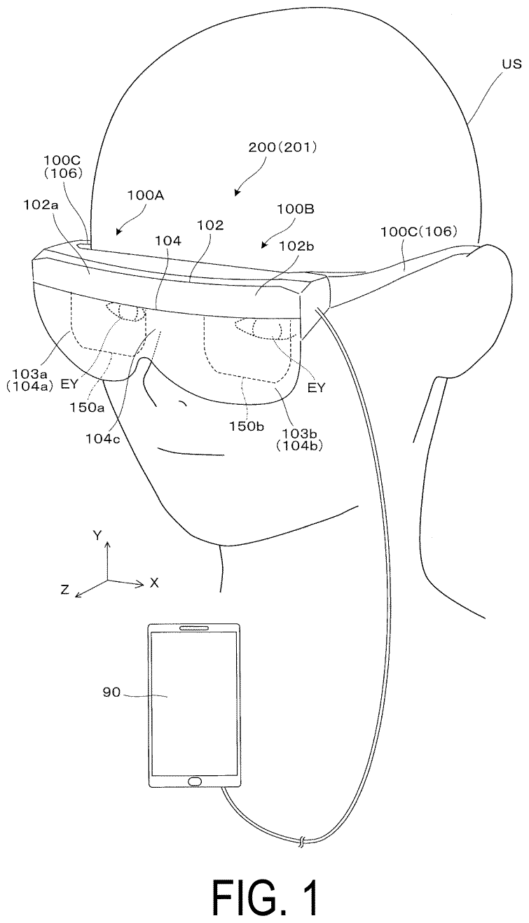

With reference to FIGS. 1 to 14, a head-mounted display apparatus according to a first embodiment of the present disclosure will be described below.

FIG. 1 is a perspective view for describing a mounted state of a head-mounted display, in other words, a head-mounted display apparatus 200. The head-mounted display apparatus (hereinafter also referred to as an HMD) 200 is a display apparatus 201 of a binocular type, and allows an observer or a wearer US who wears the HMD 200 to recognize a video as a virtual image. In FIG. 1 and the like, X, Y, and Z indicate an orthogonal coordinate system, a +X direction corresponds to a lateral direction in which both eyes EY of the observer or wearer US wearing the HMD 200 are aligned, a +Y direction corresponds to an upward direction orthogonal to the lateral direction in which both the eyes EY are aligned for the wearer US, and a +Z direction corresponds to a forward or front direction for the wearer US. The ±Y directions are parallel to a vertical axis or a vertical direction.

The HMD 200 includes a driving device 102, a shade-like member 104, a pair of temples 100C, and a user terminal 90 which is an information terminal, as external parts. The HMD 200 includes a first virtual image display device 100A for a right eye, and a second virtual image display device 100B for a left eye as optical parts. The first virtual image display device 100A includes a first display driving unit 102a arranged in front of and above the right eye in the driving device 102, and a first display optical system 103a covering the front of the eye as a whole. The second virtual image display device 100B includes a second display driving unit 102b arranged in front of and above the left eye in the driving device 102, and a second display optical system 103b covering the front of the eye as a whole. Here, the first display optical system 103a includes a first portion 104a, a third portion 104c at a center on a right side of the shade-like member 104, and a first polarization separation lens element 150a arranged behind the first portion 104a, and the like as components. The second display optical system 103b includes a second portion 104b, the third portion 104c at the center on a left side of the shade-like member 104, and a second polarization separation lens element 150b arranged behind the second portion 104b, and the like as components. That is, the third portion 104c at the center is a portion common to the first virtual image display device 100A and the second virtual image display device 100B. The HMD 200 obtained by combining the first virtual image display device 100A and the second virtual image display device 100B with each other is also a virtual image display device in a broader sense. The pair of temples 100C are mounting members or support devices 106 mounted on a head of the wearer US. The temples 100C support an upper end side of the shade-like member 104 and an upper end side of a pair of the polarization separation lens elements 150a and 150b via the display driving units 102a and 102b integrated in appearance.

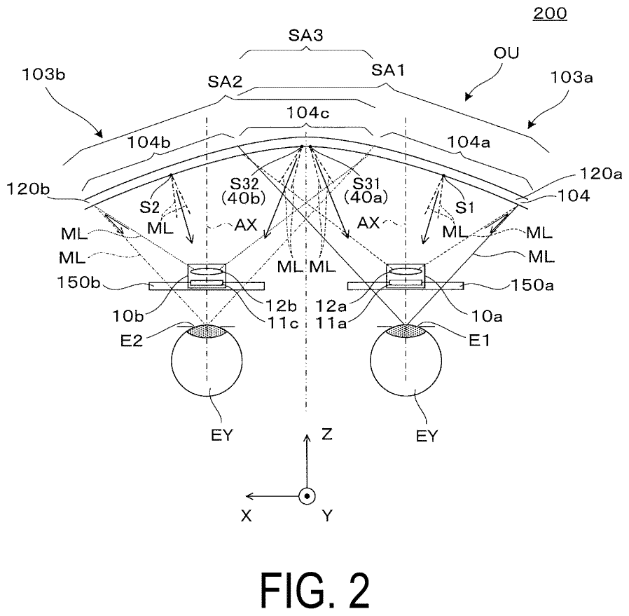

FIG. 2 is a conceptual plan view for describing a structure of the first display optical system 103a and the second display optical system 103b. The first display optical system 103a includes a first projection optical system 10a, a composite display member 120a, and the first polarization separation lens element 150a. The second display optical system 103b includes a second projection optical system 10b, a composite display member 120b, and the second polarization separation lens element 150b. The composite display member 120a for the right eye corresponds to the first portion 104a and the third portion 104c of the shade-like member 104, and is irradiated with image light ML for the right eye from the first projection optical system 10a. The composite display member 120a for the left eye corresponds to the second portion 104b and the third portion 104c of the shade-like member 104, and is irradiated with the image light ML for the left eye from the second projection optical system 10b.

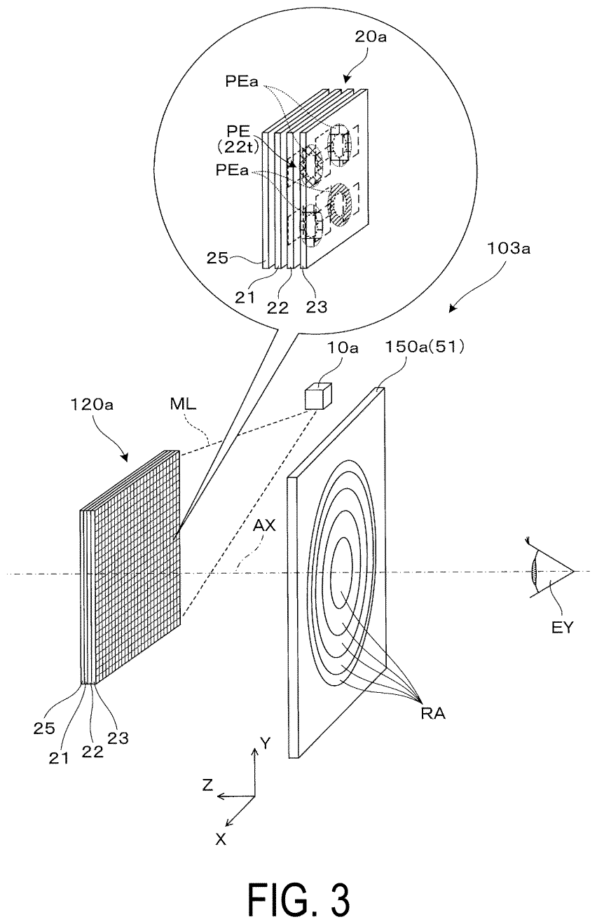

FIG. 3 is a conceptual perspective view for describing a structure of the first display optical system 103a. In the first display optical system 103a, the first projection optical system 10a is arranged in an obliquely upward direction from the composite display member 120a so that the scattering member 22 of the composite display member 120a is irradiated with the image light ML. The scattering member 22 is a passive image display member that functions as a screen for projection light or the image light ML from the first projection optical system 10a. The composite display member 120a and the first polarization separation lens element 150a are arranged separate from each other in an optical axis AX direction. In the first display optical system 103a, a distance between the eye EY and the first polarization separation lens element 150a is, for example, about 10 mm to 20 mm, to be specific, 14 mm. A distance between the eye EY and the composite display member 120a is, for example, about 50 mm to 120 mm, to be specific, 80 mm.

The second display optical system 103b illustrated in FIG. 2 is obtained by horizontally inverting the first display optical system 103a, thus, detail description the second display optical system 103b will be omitted. A combination of the first display optical system 103a and the second display optical system 103b, excluding the projection optical systems 10a and 10b, or excluding display image sources such as image display panels 11a and 11c to be described later and driving circuits thereof, is referred to as an optical unit OU.

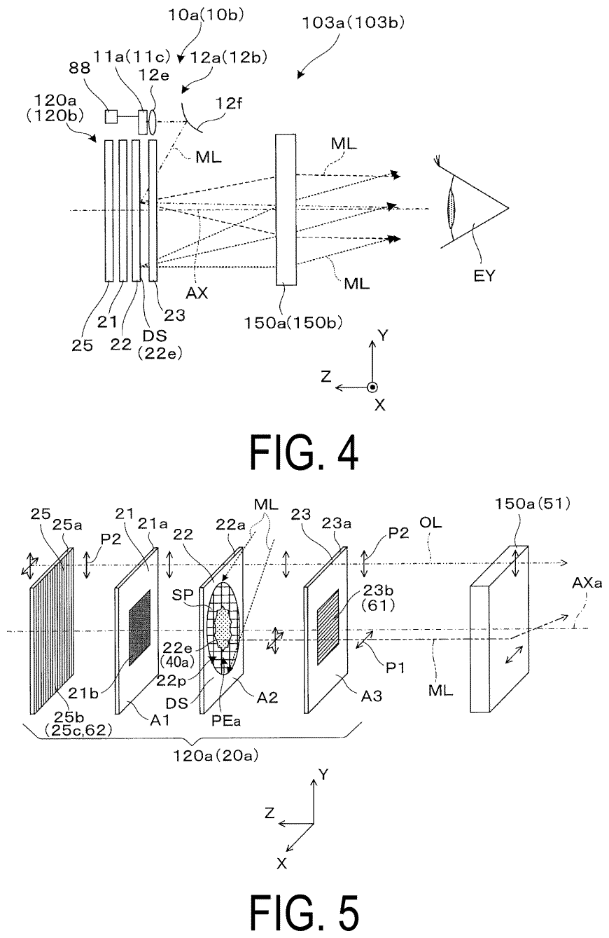

As illustrated in FIGS. 3 and 4, in the first display optical system 103a, the composite display member 120a guides the image light ML emitted from the first projection optical system 10a to the eye EY of the wearer US, that is, a pupil position of the wearer US. The composite display member 120a is a plate-like member that is arranged in a state of being inclined with respect to a state close to parallel to an XY plane perpendicular to the optical axis AX. The composite display member 120a has a structure in which an outside light polarizing member 25, a light-blocking member 21, the scattering member 22, and a pattern polarizing member 23 are layered, and integrated by a frame body (not illustrated). In the illustrated example, in order to form a spot of the image light ML on the scattering member 22 of the composite display member 120a, an arrangement is adopted in which the image light ML incident from the first projection optical system 10a is incident on the scattering member 22 via the pattern polarizing member 23.

The composite display member 120a includes a plurality of repetition units 20a arrayed in a matrix along the XY plane. The repetition unit 20a includes a pixel section 22t corresponding to a pixel PE which is a unit for forming an image. The outside light polarizing member 25, the light-blocking member 21, the scattering member 22 and the pattern polarizing member 23 are bonded and fixed in a state of being arranged nearby with predetermined intervals therebetween. This makes it possible to make the device relatively thin. Note that the outside light polarizing member 25, the light-blocking member 21, the scattering member 22 and the pattern polarizing member 23 maybe in close contact with each other. The arrangement of the scattering member 22 and the pattern polarizing member 23 is adjusted so that a polarization direction of the image light ML from the first projection optical system 10a incident on the scattering member 22 via the pattern polarizing member 23 is the same as a polarization direction of the image light ML scattered in a scattering region 22e of the scattering member 22 and passing through the pattern polarizing member 23. Note that the pattern polarizing member 23 maybe separated from the scattering member 22 in the optical axis AX direction, to cause the image light ML to be directly incident on the scattering member 22 from the first projection optical system 10a.

The first polarization separation lens element 150a functions as a lens for the image light ML. The first polarization separation lens element 150a is arranged on a face side, that is, the-Z side of the pattern polarizing member 23 of the composite display member 120a to cover the front of the eye. The first polarization separation lens element 150a is an independent lens that collectively causes a plurality of the pixels PE to form an image. That is, the first polarization separation lens element 150a collectively causes light corresponding to each pixel PE to form an image. By forming the first polarization separation lens element 150a as an independent lens, an eye box can be easily enlarged. The first polarization separation lens element 150a is a plate-like member that extends parallel to the XY plane. The first polarization separation lens element 150a is specifically a liquid crystal lens 51, and includes a plurality of orbicular zones RA each having a circular shape and a different refractive index state. The orbicular zones RA in a group are concentrically arranged symmetrically about the optical axis AX. In the group of the orbicular zones RA, the orbicular zone RA in a periphery away from the optical axis AX has a width in a radial direction with the optical axis Ax as a center, which is smaller than that of the orbicular zone RA at a center through which the optical axis AX passes. In other words, the width of the orbicular zone RA in the radial direction is smaller as approaching the periphery.

The first polarization separation lens element 150a acts on polarized light in a horizontal direction and does not act on polarized light in a perpendicular direction or the vertical direction. The first polarization separation lens element 150a acting on the polarized light in the horizontal direction has a focal point at a scattering surface DS or a position close thereto, or has refractive power comparable to a case in which the focal point is at the scattering surface DS or a position close thereto. Thus, the image light ML is emitted substantially parallel to the eye EY. As a result, an image and an external image are superimposed on the retina of the eye EY, and AR display can be performed.

FIG. 5 is a partially enlarged perspective view for describing the repetition unit 20a of the composite display member 120a. FIG. 5 illustrates a region corresponding to one sub-pixel PEa in the repetition unit 20a. Here, an axis AXa is an axis parallel to the optical axis AX illustrated in FIG. 2.

The outside light polarizing member 25 is a second polarizing member 62, is arranged closest to an outside world, restricts the external light OL in a second polarization direction, specifically, to vertically polarized light that is polarized light in the perpendicular direction, and blocks polarized light in a first polarization direction orthogonal to the second polarization direction, specifically, horizontally polarized light that is polarized light in the horizontal direction. In the illustrated embodiment, the horizontally polarized light is polarized light having a polarization plane parallel to left and right ±X directions, and the vertically polarized light is polarized light having a polarization plane parallel to the up and down ±Y directions. In FIG. 5 and other drawings, the horizontally polarized light is indicated by “P1” and the vertically polarized light is indicated by “P2”. The outside light polarizing member 25 is obtained by bonding a polarizing film 25b of an absorbing type at a flat plate 25a that transmits light. The polarizing film 25b may be, for example, a resin sheet obtained by extending polyvinyl alcohol (PVA) with iodine adsorbed thereon in a specific direction. In the illustrated example, the polarizing film 25b blocks the first polarized light P1 having a polarization plane parallel to the left and right ±X directions by absorption, but the polarizing film 25b may block the first polarized light P1 by reflection. The polarizing film 25b that blocks polarized light by reflection is, for example, a wire grid type polarizing plate, and a fine grid made of metal such as aluminum is formed at a flat plate 23a made of glass or the like. The polarizing film 25b restricts the external light OL in the second polarization direction, and is also referred to as a second polarizing region 25c.

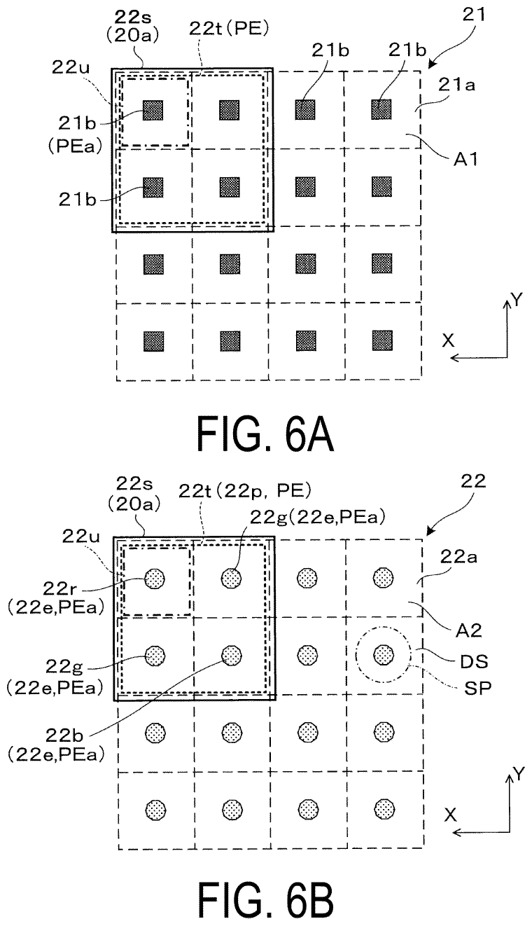

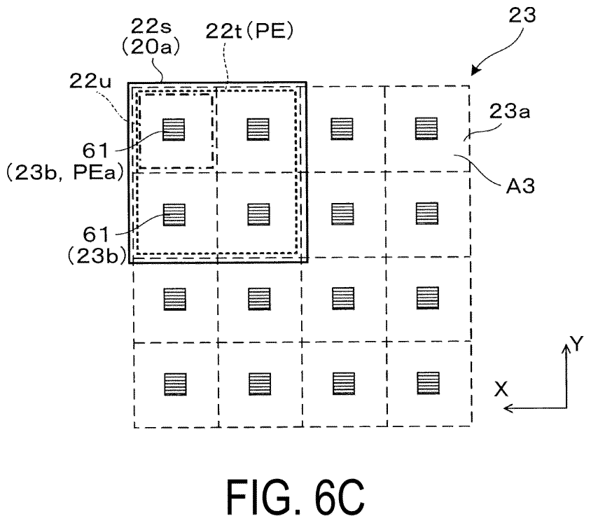

The light-blocking member 21 suppresses incidence of external light OL on the scattering region 22e of the scattering member 22. The light-blocking member 21 is obtained by providing a rectangular light-blocking layer 21b at a flat plate 21a that transmits light. As illustrated in FIG. 6A, at the entire light-blocking member 21, a large number of the light-blocking layers 21b are arrayed in a matrix along the XY plane. In other words, all the light-blocking layers 21b constituting the light-blocking member 21 are two-dimensionally arrayed periodically with respect to a horizontal X direction and a vertical Y direction. Each of the light-blocking layers 21b is formed in a region corresponding to the sub-pixel PEa of the pixel section 22t in each of the repetition units 20a. Note that the light-blocking layer 21b may be formed in a region corresponding to a part of the pixel section 22t including the four sub-pixels PEa (for example, in a minimum rectangular frame surrounding the four sub-pixels PEa), as long as the region is not in a common observation region described later. The light-blocking layer 21b blocks light in a range equivalent to that of the sub-pixel PEa constituting the pixel PE or wider than that of the sub-pixel PEa. The light-blocking layer 21b has a size corresponding to that of the scattering region 22e. In this manner, incidence of the external light OL on the scattering region 22e can be suppressed. A light-transmitting region A1 of the light-blocking member 21 in which the light-blocking layer 21b is not provided transmits the external light OL, and the light-blocking layer 21b suppresses passage of the external light OL.

The light-blocking layer 21b is formed by light-absorbing paint or other substances that can be applied to a desired area by an ink-jet method, for example. A mold release pattern formed with a mold release agent is recorded in advance at a position at the flat plate 21a at which the light-blocking layer 21b is not formed. A spray containing light-absorbing substances is applied over the entire surface, and then the light-absorbing substances are removed at the position corresponding to the mold release pattern. With this, the light-blocking layer 21b may be made of the remaining light-absorbing substance layer. Paint having a color other than black may be used for the light-blocking layer 21b as long as substances contained therein have a light-absorbing action or a light-reflecting action. Moreover, a metal pattern is formed by using a photo-resist technique or the like at a position on the flat plate 21a at which the light-blocking layer 21b is to be formed, and the metal pattern is oxidized to improve an absorbing property. The light-blocking layer 21b may be thus formed. The light-blocking layer 21b may be a mirror made of a substance having reflectivity such as a metallic film. Note that the light-blocking layer 21b is not limited to one formed at a face of the flat plate 21a and may be formed at the external side of the flat plate 21a.

The scattering member 22 illustrated in FIG. 5 and the like is arranged on the face side of the light-blocking member 21. The scattering member 22 scatters a part of the image light ML irradiated from the first projection optical system 10a illustrated in FIG. 4 toward the eye EY of the wearer US, and functions as an image display member in the composite display member 120a. The scattering member 22 includes the scattering regions 22e corresponding to red, green, and blue at a flat plate 22a that transmits light. The scattering member 22 includes, at the scattering surface DS, a pixel display region 22p irradiated with a sub-pixel spot SP from a first image display panel 11a. The pixel display region 22p is a region that includes the sub-pixel PEa constituting the pixel PE, and on which the image light ML or the sub-pixel spot SP is incident. The scattering region 22e is formed in a range narrower than the pixel display region 22p.

The scattering region 22e is a structure such as a nanostructure that scatters light to the eye EY side. The scattering region 22e includes a polygonal or circular outline in plan view. The nanostructure of the scattering region 22e is formed by nanoimprint lithography, photolithography, or the like.

Of light with which the pixel display region 22p is irradiated, light incident on the scattering region 22e is scattered to the eye EY side, that is, forward, and light incident on a light-transmitting region A2 other than the scattering region 22e is transmitted or reflected and thus does not proceed to the eye EY side.

The flat plate 22a, which is a substrate provided with the scattering region 22e is made of glass or plastic that transmits light. At the flat plate 22a, the scattering region 22e corresponding to one sub-pixel PEa is formed in the pixel display region 22p. The scattering region 22e has a one-to-one relationship with the sub-pixel PEa, and one scattering region 22e is irradiated with the sub-pixel spot SP corresponding to one sub-pixel PEa. Of the pixel section 22t, the scattering region 22e is a region equivalent to that of the light-blocking layer 21b or smaller than that of the light-blocking layer 21b. The sub-pixel spot SP is larger than the scattering region 22e, and has a size such that the sub-pixel spot SP does not enter the adjacent scattering region 22e. By controlling an irradiation state (angular direction or range) of light corresponding to each sub-pixel PEa from the first projection optical system 10a, it is possible to selectively scatter the image light ML in the scattering region 22e.

As illustrated in FIG. 6B, at the scattering member 22, repetition sections 22s each having a rectangular outline are arrayed in the X direction and the Y direction. Each repetition section 22s includes the pixel section 22t or the pixel PE, and the pixel section 22t includes a plurality of sub-pixel sections 22u. In the sub-pixel section 22u, the light-transmitting region A2 is formed around the scattering region 22e corresponding to the sub-pixel PEa. The pixel section 22t is the pixel display region 22p for displaying an image. The pixel section 22t includes the four scattering regions 22e arrayed in 2×2. In the scattering member 22 of the first display optical system 103a, a size of a region where the pixels PE are formed is about (several tens of mm)×(100 and several tens of mm), and the number of pixels is about 2K to 4K. A size of the sub-pixel section 22u including the sub-pixel PEa is, for example, about 10 μm square to 30 μm square. A size of the scattering region 22e is, for example, about 5 μm square to 20 μm square. In order to ensure see-through light, (scattering region area)/(sub-pixel section area) is, for example, about 0.3 to 0.8. For example, when the pixel section 22t is 24 μm square, that is, when the sub-pixel section 22u is 12 μm square, the scattering region 22e is 8 μm square.

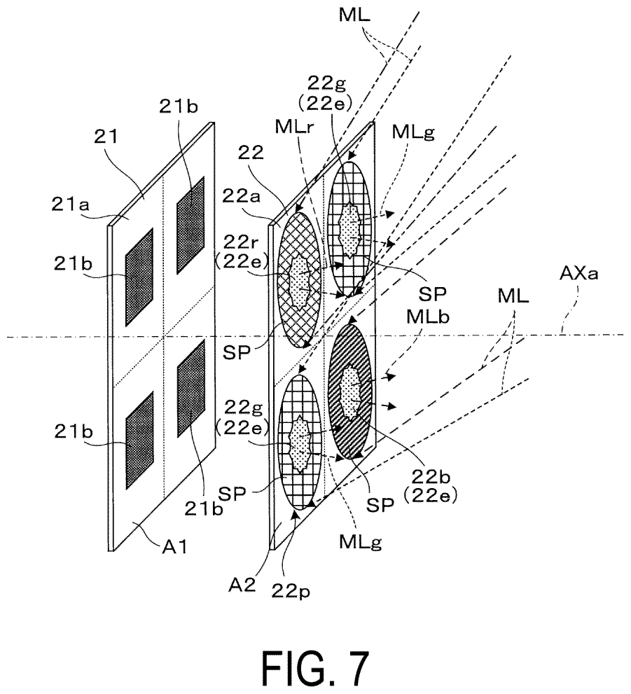

As illustrated in FIG. 7, in the scattering member 22, for example, in the pixel display region 22p of one pixel, the scattering regions 22e for respective colors, to be specific, a scattering region 22r for red, a pair of scattering regions 22g for green, and a scattering region 22b for blue are provided. The scattering region 22r for red emits red image light MLr at timing and brightness necessary for display in accordance with light irradiation or the sub-pixel spot SP from the first projection optical system 10a. The pair of scattering regions 22g for green emit green image light MLg at timing and brightness necessary for display in accordance with light irradiation or the sub-pixel spot SP from the first projection optical system 10a. The scattering region 22b for blue emits blue image light MLb at timing and brightness necessary for display in accordance with light irradiation or the sub-pixel spot SP from the first projection optical system 10a. As illustrated in FIG. 6B, at the entire scattering member 22, a large number of the pixels PE each including a group of the four scattering regions 22r, 22g and 22b are arrayed in a matrix along the XY plane. In other words, all the pixels PE or all the groups of the scattering regions 22r, 22g and 22b that constitute the scattering member 22 are two-dimensionally arrayed periodically with respect to the horizontal X direction and the vertical Y direction. Of the scattering member 22, the light-transmitting region A2 in which the scattering regions 22r, 22g and 22b are not provided transmits the external light OL.

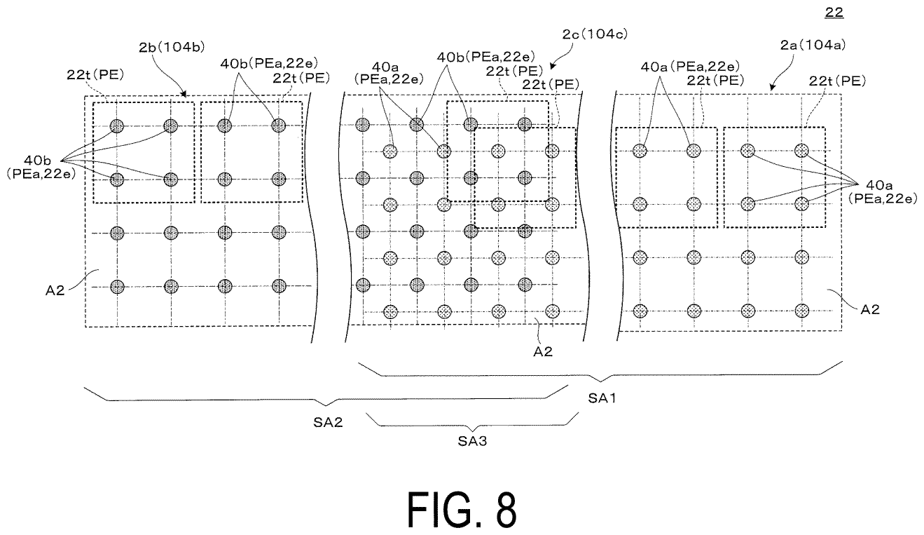

A structure or distribution of the scattering member 22 in the shade-like member 104 illustrated in FIG. 2 and the like will be described with reference to FIG. 8. In the drawing, a right side is an enlarged view of the first portion 2a of the scattering member 22 and corresponds to the first portion 104a of the shade-like member 104, a left side is an enlarged view of the second portion 2b of the scattering member 22 and corresponds to the second portion 104b of the shade-like member 104, and a center is an enlarged view of the third portion 2c of the scattering member 22 and corresponds to the third portion 104c of the shade-like member 104. The scattering member 22 includes a first observation region SA1 for the right eye and a second observation region SA2 for the left eye that partially overlap each other. The first observation region SA1 is provided at the first portion 104a and the third portion 104c of the shade-like member 104 corresponding to the composite display member 120a, and the second observation region SA2 is provided at the second portion 104b and the third portion 104c of the shade-like member 104 corresponding to the composite display member 120b. In a common observation region SA3 where the first observation region SA1 and the second observation region SA2 overlap each other, the first scattering region 40a and the second scattering region 40b are arranged in a staggered manner. That is, the first scattering regions 40a and the second scattering regions 40b are arranged, while maintaining a pixel pattern of scattering regions on one side, in upper, lower, left, and right gaps of a pixel pattern of scattering regions on another side. The pixel pattern of the scattering regions on the one side is shifted with respect to the pixel pattern of the scattering region on the other side. The pixel pattern may be shifted without changing density between the first or second observation region SA1, SA2 and the common observation region SA3, or may be continuously changed.

By sufficiently separating the first polarization separation lens element 150a and the second polarization separation lens element 150b from the shade-like member 104 provided with the scattering member 22, it becomes easy to widen the eye box. On the other hand, it is necessary to provide the common observation region SA3 for forming an image common to both the eyes EY in the scattering member 22. For this reason, by arranging the first scattering region 40a and the second scattering region 40b in a staggered manner in the common observation region SA3, it is easy to secure a visual field angle toward a direction of the eye EY on another side. That is, a visual field angle in the left direction can be widened for the right eye, and a visual field angle in the right direction can be widened for the left eye.

The scattering regions 22e in the first observation region SA1, that is, the first scattering regions 40a that scatter the image light ML for the right eye are two-dimensionally arranged in a matrix, and are arranged on lattice points of a square lattice in the illustrated example. The four first scattering regions 40a form the pixel PE, and the four first scattering regions 40a forming each pixel PE are each the sub-pixel PEa. The scattering regions 22e in the second observation region SA2, that is, the second scattering regions 40b that scatter the image light ML for the left eye are two-dimensionally arranged in a matrix, and are arranged on lattice points of a square lattice in the illustrated example. The four second scattering regions 40b form the pixel PE, and the four second scattering regions 40b forming each pixel PE are each the sub-pixel PEa.

In the common observation region SA3, the first scattering regions 40a formed in the first observation region SA1 and the second scattering regions 40b formed in the second observation region SA2 are formed so as to overlap each other, and mutual gratings are in a state of being shifted by ½ of a grating interval. That is, in the common observation region SA3, the first scattering regions 40a and the second scattering regions 40b are each arranged in a square lattice shape or a rectangular lattice shape, and are arranged in a face-centered square lattice shape or a face-centered rectangular lattice shape as a whole. In the first observation region SA1 and the second observation region SA2, the first scattering regions 40a and the second scattering regions 40b are arranged on the lattice points in a well-balanced manner, and thus quality such as resolutions of images observed by both the eyes EY can be improved as a whole. In particular, in the common observation region SA3 corresponding to a common line-of-sight direction of both the eyes EY, since the grating of the first scattering regions 40a and the grating of the second scattering regions 40b are in a state of being shifted by ½ of the grating interval, it is easy to suppress occurrence of blur of pixels between the pixels PE or the sub-pixels PEa. That is, it becomes easy to ensure display balance of images for both the eyes EY while ensuring image quality when observing the common observation region SA3.

The first observation region SA1 is an anisotropic scattering portion, and anisotropic scatterers are formed at a front surface thereof. The first observation region SA1 is, for example, a nanostructure, and has scattering characteristics in which scattering efficiencies are increased in a direction of the eye EY by the nanostructure.

Referring to FIG. 2, in the common observation region

SA3, the first scattering region 40a at an optional position S31 scatters the image light ML for the right eye incident from the first projection optical system 10a so as to be reflected in an angular direction within a relatively narrow range toward an eye point E1 where the right-eye is present. Further, in the common observation region SA3, the second scattering region 40b at an optional position S32 scatters the image light ML for the left eye incident from the second projection optical system 10b so as to be reflected in an angular direction within a relatively narrow range toward an eye point E2 where the left-eye is present. Note that, in a single observation region corresponding to the first portion 104a in the first observation region SA1, the first scattering region 40a at an optional position S1 scatters the image light ML for the right eye incident from the first projection optical system 10a so as to be reflected in an angular direction within a relatively narrow range toward the eye point E1. In addition, in a single observation region corresponding to the second portion 104b in the second observation region SA2, the second scattering region 40b at an optional position S2 scatters the image light ML for the left eye incident from the second projection optical system 10b so as to be reflected in an angular direction within a relatively narrow range toward the eye point E2. As described above, in the scattering member 22, the first scattering region 40a and the second scattering region 40b have an angle characteristic matching the line-of-sight direction in which the image light ML is emitted toward the corresponding eye points E1 and E2. Accordingly, the image light ML from the first scattering region 40a can be efficiently emitted toward a position of the right eye, and the image light ML from the second scattering region 40b can be efficiently emitted toward a position of the left eye. That is, it is possible to cause the image light ML for the right eye to be efficiently incident on the first polarization separation lens element 150a, and cause the image light ML for the left eye to be efficiently incident on the second polarization separation lens element 150b, and it is possible to prevent images for the left and right eyes from interfering with each other. In particular, in the common observation region SA3 where the first observation region SA1 and the second observation region SA2 are common to each other, the first scattering region 40a directs the image light ML for the right eye from the first projection optical system 10a to the first polarization separation lens element 150a for the right eye or the eye point E1, and the second scattering region 40b directs the image light ML for the left eye from the second projection optical system 10b to the second polarization separation lens element 150b for the left eye or the eye point E2, thus it is possible to present independent and consistent images for the left and right eyes EY.

In the above description, the first observation region SA1 for the right eye and the second observation region SA2 for the left eye provided at the scattering member 22 partially overlap each other, but the common observation region SA3 is not essential. When the common observation region SA3 is omitted, the first observation region SA1 and the second observation region SA2 are spatially separated and independent from each other.

The pattern polarizing member 23 illustrated in FIG. 5 and the like is arranged on the face side of the scattering member 22. The pattern polarizing member 23 restricts the image light ML in the first polarization direction different from the second polarization direction, to be more specific, to the horizontally polarized light. As a result, as the external light OL and the image light ML pass through the outside light polarizing member 25 and the pattern polarizing member 23, the polarization directions of the external light OL and the image light ML become different from each other.

The pattern polarizing member 23 includes, as a first polarizing member 61, a rectangular first polarizing region 23b at the flat plate 23a that transmits light. As illustrated in FIG. 6C, at the entire pattern polarizing member 23, a large number of the first polarizing members 61 or the first polarizing regions 23b are arrayed in a matrix along the XY plane. In other words, all the first polarizing members 61 constituting the pattern polarizing member 23 are two-dimensionally arrayed periodically with respect to the horizontal X direction and the vertical Y direction. The first polarizing members 61 or the first polarizing regions 23b are arranged so as to be separated from each other at intervals equal to or larger than sizes thereof, and are discretely provided corresponding to the scattering regions 22e. The first polarizing member 61 restricts the image light ML scattered in the scattering region 22e of the scattering member 22 to the horizontally polarized light (first polarized light P1) in the first polarization direction orthogonal to the second polarization direction. In the pattern polarizing member 23, a region other than the first polarizing member 61 or the first polarizing region 23b is a light-transmitting region A3, and the external light OL passing through the light-transmitting region A3 is not restricted to the polarization direction. Note that all of the first polarizing members 61 or the first polarizing regions 23b are not limited to be discretely provided, and some of the first polarizing members 61 or the first polarizing regions 23b may be coupled to each other to an extent that polarizing control for the image light ML is not affected.

The pattern polarizing member 23 is, for example, a wire grid type polarizing plate and a fine grid made of metal such as aluminum is formed at the flat plate 23a made of glass or the like.

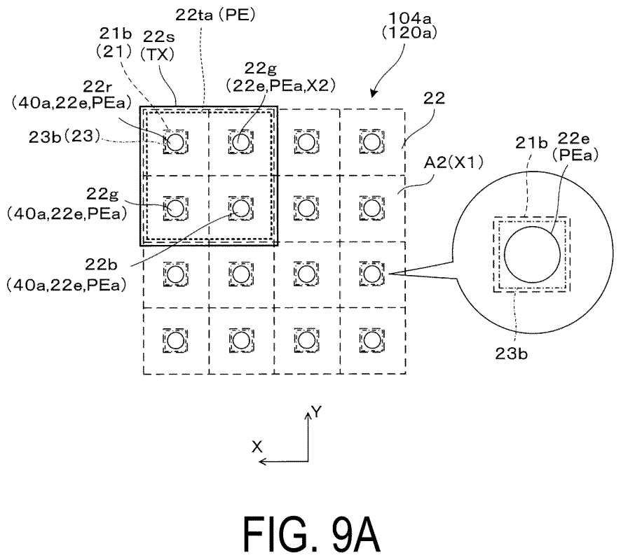

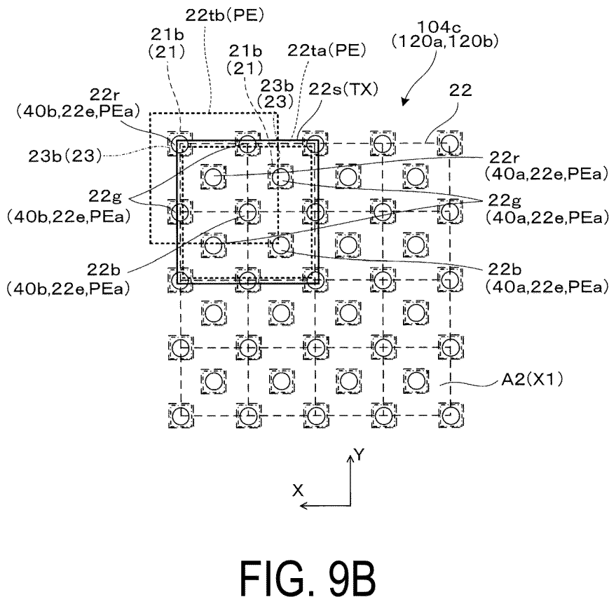

FIG. 9A is a diagram in which for a part of the scattering member 22 corresponding to the first portion 104a illustrated in FIG. 2, the light-blocking member 21 and the pattern polarizing member 23 in a state of being seen-through are superimposed on each other and illustrated. In this case, the light-blocking layer 21b of the light-blocking member 21 is formed in a region that has a size corresponding to that of the sub-pixel PEa or the first scattering region 40a of a pixel section 22ta for the right eye to cover the sub-pixel PEa, and that spreads slightly outward from the sub-pixel PEa, but may be formed in a region matching with the sub-pixel PEa. In addition, the light-blocking layer 21b of the light-blocking member 21 maybe provided corresponding to a quadrangular frame surrounding a plurality of the sub-pixels PEa. The first polarizing region 23b of the pattern polarizing member 23 is formed in a region that covers the sub-pixel PEa of the pixel section 22ta for the right eye, and that spreads slightly outward from the sub-pixel PEa, but may be formed in a region matching with the sub-pixel PEa.

FIG. 9B is a diagram in which for a part of the scattering member 22 corresponding to the third portion 104c illustrated in FIG. 2, the light-blocking member 21 and the pattern polarizing member 23 in a state of being seen-through are superimposed on each other and illustrated. The pixel section 22ta for the right eye and a pixel section 22tb for the left eye partially overlap each other, but the first scattering regions 40a corresponding to the sub-pixels PEa for the right eye and the second scattering regions 40b corresponding to the sub-pixels PEa for the left eye are alternately arranged with a shift of ½ of the grating interval. However, both the sub-pixel PEa for the right eye and the sub-pixel PEa for the left eye are covered by the light-blocking layer 21b because the light-blocking layer 21b of the light-blocking member 21 has a size corresponding to that of the sub-pixel PEa or the scattering region 40a or 40b, and the first polarizing region 23b of the pattern polarizing member 23 is covered by the light-blocking member 21 slightly widely.

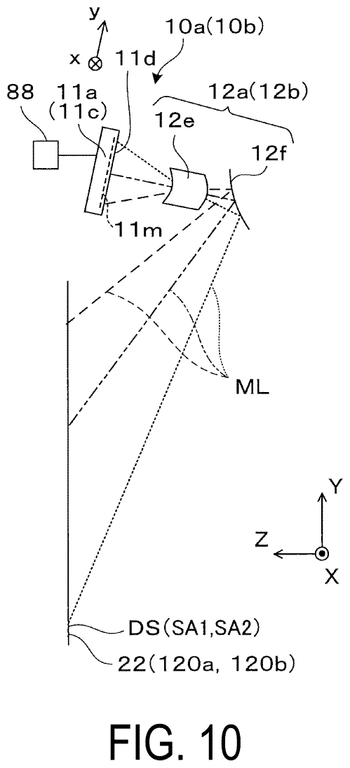

The first projection optical system 10a illustrated in FIGS. 2 to 4, and 10 forms a two-dimensional image, and emits the image light ML from the image. As illustrated in FIGS. 4 and 10, the first projection optical system 10a includes the first image display panel 11a, a first imaging optical system 12a and a display control device 88. The first projection optical system 10a projects light emitted from a light-emitting region of the first image display panel 11a as the image light ML onto the scattering surface DS of the scattering member 22, to be specific, onto the first scattering region 40a. That is, an image on the first image display panel 11a is projected onto the corresponding scattering region 22e (to be specific, the first scattering region 40a of the composite display member 120a), and an image to be displayed is formed on the scattering member 22.

In the first projection optical system 10a, the first image display panel 11a is a self-luminous image light generating device. The first image display panel 11a is, for example, an organic electroluminescence (EL) display, and forms a color still image or moving image on a two-dimensional display surface 11d. The first image display panel 11a is driven by the display control device 88 to perform display operation. The first image display panel 11a is not limited to the organic EL display, and can be replaced with a display device using inorganic EL, an organic LED, an LED array, a laser array, a quantum dot light emission element, or the like. The first image display panel 11a is not limited to a self-luminous image light generating device and may be made of an LCD or other light modulation element and form an image by illuminating the light modulation element with a light source such as a backlight. As the first image display panel 11a, a liquid crystal on silicon (LCOS) (trade name), a digital micromirror device, or the like can be used instead of an LCD.

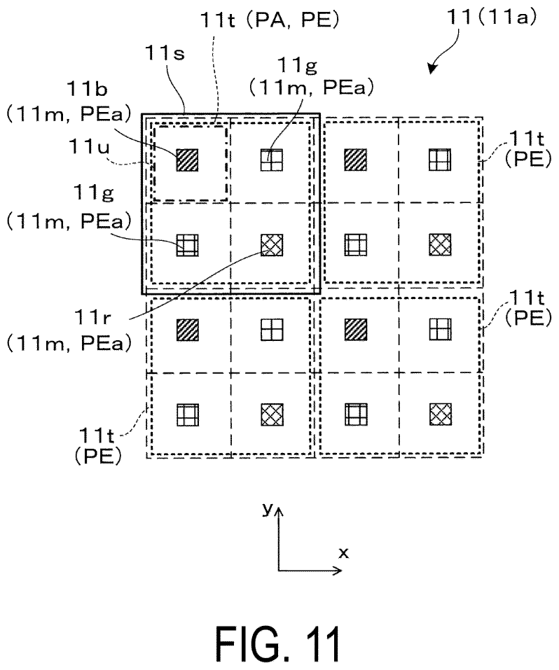

As illustrated in FIG. 11, in the first image display panel 11a, repetition sections 11s each having a rectangular outline are arrayed in an x direction and a y direction, each repetition section 11s includes a pixel section 11t, and the pixel section 11t includes a plurality of sub-pixel sections 11u. The pixel section 11t is a pixel display region PA for displaying an image. The pixel section 11t includes, for example, four light-emitting regions 11m arrayed in 2×2 in the sub-pixel section 11u or, to be more specific, light-emitting regions 11r, 11g and 11b in a Bayer array. That is, at the first image display panel 11a, for example, a large number of the pixels PE each including a group of the four light-emitting regions 11r, 11g and 11b are arrayed in a matrix along an xy plane. The pixel section 11t corresponds to the pixel PE. Each of the light-emitting regions 11r, 11g and 11b corresponds to the sub-pixel PEa in the sub-pixel section 11u. The repetition section 11s corresponds to the repetition unit 20a of the composite display member 120a illustrated in FIGS. 3 and 6B. All the pixels PE or all the groups of the light-emitting regions 11r, 11g and 11b that constitute the first image display panel 11a are two-dimensionally arrayed periodically with respect to the x direction and the vertical y direction. In the illustrated example, the pixels PE or the light-emitting regions 11r, 11g and 11b are arranged to be horizontally inverted with respect to projection on the scattering surface DS of the scattering member 22. The first image display panel 11a selectively causes the light-emitting regions 11r, 11g and 11b to emit light by the display control device 88.

As illustrated in FIGS. 4 and 10, the first imaging optical system 12a includes a projection lens 12e and a reflection mirror 12f. The first image display panel 11a and the first imaging optical system 12a correspond to a part of the first display driving unit 102a illustrated in FIG. 1. The first image display panel 11a and the first imaging optical system 12a are fixed in a case (not illustrated) in a state of being aligned with each other. The first imaging optical system 12a forms an image of the image light ML on the scattering surface DS of the scattering member 22. Light from the sub-pixel PEa is formed as the sub-pixel spot SP in the pixel display region 22p of the scattering member 22 by the first imaging optical system 12a.

Although detailed description is omitted, similarly to the first projection optical system 10a, the second projection optical system 10b also includes the second image display panel 11c for displaying an image and a second imaging optical system 12b. The second projection optical system 10b projects, by the second imaging optical system 12b, light emitted from a light-emitting region of the second image display panel 11c as the image light ML onto the scattering surface DS of the scattering member 22 provided at the composite display member 120b illustrated in FIGS. 2 and 9B, to be specific, onto the second scattering region 40b. That is, an image on the second image display panel 11c is projected onto the corresponding scattering regions 22e (to be specific, the second scattering region 40b of the composite display member 120b), and an image to be displayed is formed on the scattering member 22.

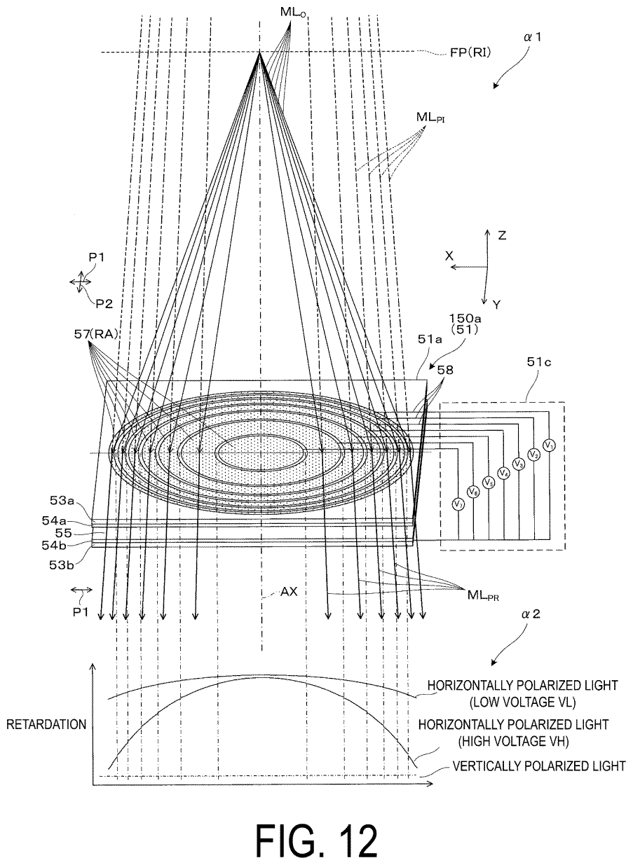

FIG. 12 is a diagram for describing a structure and a function of the first polarization separation lens element 150a or the liquid crystal lens 51. In FIG. 12, an upper side α1 is a conceptual perspective view of the liquid crystal lens 51, and a lower side α2 is a chart illustrating a distribution state of retardation of the liquid crystal lens 51. The liquid crystal lens 51 is an optical element serving as a lens with respect to a specific polarization component. The liquid crystal lens 51 has refractive power that selectively acts on polarized light of the image light ML, and the refractive power is set for each of the orbicular zones RA. When vertically polarized light and horizontally polarized light are incident, the liquid crystal lens 51 selectively acts as a lens on the horizontally polarized light (first polarized light P1) in one direction according to distribution of a refractive index, and transmits the vertically polarized light (second polarized light P2) in another direction substantially as is without acting thereon. Here, the polarized light in the one direction specifically corresponds to the image light ML that is the horizontally polarized light including a polarization plane along the horizontal direction. The polarized light in the other direction specifically corresponds to the external light OL that is the vertically polarized light including a polarization plane along the vertical direction. The liquid crystal lens 51 can be used with a fixed focus, but may also be used with a variable focus. When the distribution of the refractive index on the liquid crystal lens 51 is increased or reduced overall, the refractive power of the liquid crystal lens 51 can be increased or reduced, and the liquid crystal lens 51 can be used with a variable focus.

The liquid crystal lens 51 as the polarization separation lens element 150a includes a lens member 51a and a driving circuit 51c. The lens member 51a includes two light-transmitting substrates 53a and 53b facing each other, two electrode layers 54a and 54b provided on inner surface sides of the light-transmitting substrates 53a and 53b, and a liquid crystal layer 55 interposed between the electrode layers 54a and 54b. Note that although not illustrated in the drawing, alignment films are arranged between the electrode layers 54a and 54b and the liquid crystal layer 55 to adjust an initial alignment state of the liquid crystal layer 55. The first electrode layer 54a includes a large number of electrodes 57 arranged concentrically along the XY plane in the orbicular zone RA, and the electrodes 57 are annular transparent electrodes. The large number of electrodes 57 are spaced apart from each other, and a lateral width of the electrode 57 located on an outer side is narrowed. The lateral width of the electrode 57 affects accuracy of a refraction action of the lens member 51a. Each electrode 57 is coupled to the driving circuit 51c via a wiring line 58 insulated by an insulating layer (not illustrated), on a route in the middle. The second electrode layer 54b is a common electrode extending parallel to the XY plane, and is uniformly formed along the light-transmitting substrate 53b. Different application voltages V1 to V7 are applied to the large number of electrodes 57 to adjust a distribution state of birefringence or retardation. When the liquid crystal lens 51 has an effect of a convex lens, the application voltage V1 is set higher than the application voltage V7, and the application voltages V2 to V6 are set to values gradually changed within a voltage range of V1 to V7.

A case in which the image light ML emitted from the scattering member 22 is incident on the liquid crystal lens 51 via the pattern polarizing member 23 and the like, that is, a case in which horizontally polarized light (first polarized light P1) including a polarization plane parallel to the X direction is incident on the liquid crystal lens 51 is considered. With regard to the horizontally polarized light, a voltage applied to the electrode 57 that is arranged at the outermost side in the peripheral portion is increased to reduce retardation, and the refractive index is relatively reduced in the region. Thus, for example, in a case of light from a far point light source, the light that passes through the liquid crystal lens 51 via the electrode 57 in the peripheral portion has a wavefront that is relatively advanced. In contrast, a voltage applied to the electrode 57 that is arranged at the innermost side being the center portion is reduced to maintain retardation close to its original state, and the refractive index is relatively increased in the region. Thus, for example, in a case of light from a far point light source, the light that passes through the liquid crystal lens 51 via the electrode 57 in the center portion has a wavefront that is relatively delayed. Thus, image light ML₀ in a diverging state that is incident on the liquid crystal lens 51 from an image RI set on a predetermined focal plane FP is horizontally polarized light, passes through the liquid crystal lens 51 to be subjected to an action as a convex lens, and becomes image light ML_{PR} in a state in which a diverging angle is reduced. Virtual image light ML_{PI} that traces back the image light ML_{PR} is from a virtual image position farther than the focal plane FP. A focal length of the liquid crystal lens 51 is a distance from a point light source to the liquid crystal lens 51 when light from the point light source is collimated. In the embodiment, the focal length is substantially equal to a distance from the scattering member 22 to the liquid crystal lens 51. Approximately, with reference to the lens formula, the relationship expressed by 1/F=1/A+1/B is satisfied, where a distance from the focal plane FP to the liquid crystal lens 51 is A, a distance from the liquid crystal lens 51 to an image plane is B, and the focal length of the liquid crystal lens 51 is F.

Here, the distance B from the focal plane FP to the virtual image position is set to a distance as several times to several tens of times as long as the distance A from the liquid crystal lens 51 to the focal plane FP. Although detail description is omitted, the distance ratio corresponds to a magnification ratio of a virtual image. In the above, when a relative ratio of the application voltages V1 to V7 is substantially maintained so that the application voltages are set to be low, a difference in retardation between the center and the periphery decreases, and an absolute value of positive power of the liquid crystal lens 51 decreases. That is, the absolute value of the power can be increased by applying a high voltage VH to the liquid crystal lens 51, the absolute value of the power can be decreased by applying a low voltage VL to the liquid crystal lens 51, and the driving circuit 51c can cause the liquid crystal lens 51 to function as an externally adjustable varifocal lens.

When the liquid crystal lens 51 functions as a varifocal lens, a focal length F changes, thus the distance B from the liquid crystal lens 51 to the image plane position or the virtual image position can freely be changed, and adjustment of a magnification ratio can be performed. Further, even when visual acuity of the wearer US is imbalanced due to nearsightedness or the like, focus adjustment for observing a virtual image while maintaining a focused state can be performed. In other words, the image plane position or the virtual image position can be adjusted finely according to visual acuity of an individual (farsightedness, nearsightedness, astigmatism, or the like). The wearer US can perform adjustment of a magnification ratio or focus adjustment by operating the user terminal 90, for example. In other words, the virtual image display devices 100A and 100B enable customization relating to a magnification ratio and focus by an operation by the wearer US.

The liquid crystal lens 51 has an image formation action with respect to the image light ML that is the horizontally polarized light, and has an image formation action with respect to the image light ML being the vertically polarized light by adjusting a rotation angle. The liquid crystal lens 51 maybe regarded as a liquid crystal lens serving as a lens with respect to a specific polarization component, and may also be regarded as a liquid crystal lens having a lens function of acting on a specific polarization component. When the liquid crystal lens 51 is arranged in front of the eyes, an eye box having a size close to that of the liquid crystal lens 51 can be secured. The eye box can be increased in size, and chipping of an image is less likely to occur. Moreover, the first display optical system 103a that is reduced in size and has a large FOV can be achieved at the same time. Moreover, by combining the composite display member 120a including the scattering member 22, the pattern polarizing member 23, and the like, with the liquid crystal lens 51, display on a large screen can be performed with a small-sized optical system. Here, display on a large screen indicates a case in which a virtual image of 70 inches or larger is formed at a distance of 2.5 m ahead, for example.

The liquid crystal lens 51 is not limited to one in which retardation is gradually reduced from the center to the periphery, but may also be a Fresnel lens as disclosed, for example, in WO 2009/072670. The liquid crystal lens 51 may change an alignment direction of liquid crystal by ultrasonic waves.

Note that the external light OL that passes through the light-blocking member 21 and the like is the vertically polarized light (second polarized light P2), and even when the external light OL passes through the liquid crystal lens 51, retardation is kept uniform in the XY plane regardless of the values of the application voltages V1 to V7. Thus, a phase difference is not imparted, and the external light OL is not affected by a lens action of the liquid crystal lens 51. In other words, the external light OL linearly advances without being substantially affected by the composite display member 120a and the first polarization separation lens element 150a.

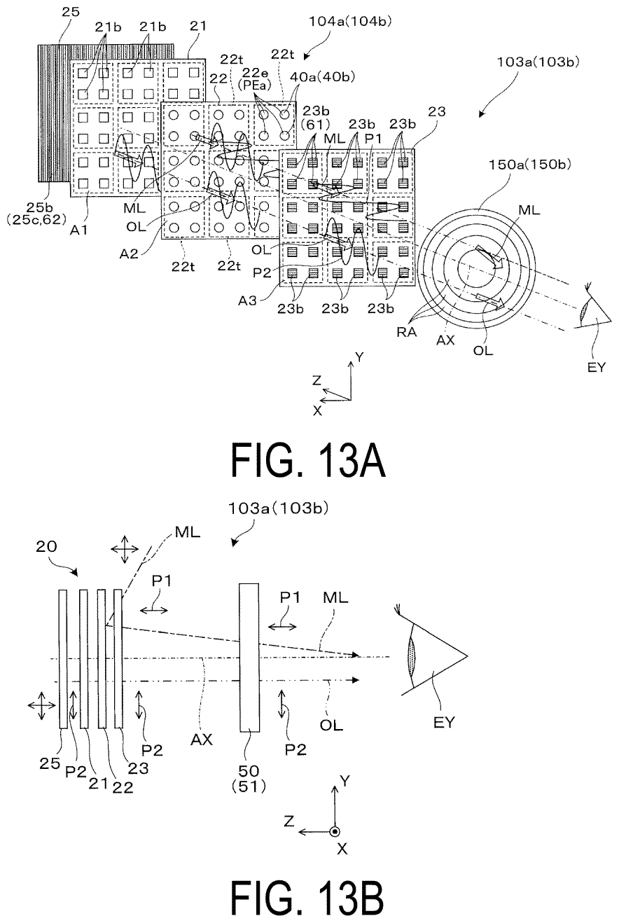

FIGS. 13A and 13B describe a case where the image light ML solely for the right eye emitted from the first portion 104a is observed. In the first display optical system 103a, the image light ML scattered by the scattering member 22 passes through the first polarizing member 61 or the first polarizing region 23b of the pattern polarizing member 23 and is emitted as the first polarized light P1, to be more specific, as the horizontally polarized light. The image light ML that passes through the first polarizing member 61 forms a virtual image via the liquid crystal lens 51 as the first polarization separation lens element 150a functioning as a convex lens with respect to the horizontally polarized light. An image that is formed at the first image display panel 11a or the scattering member 22 is observed by the eyes EY of the wearer US as a virtual image at a desired magnification ratio behind the scattering member 22. On the other hand, the external light OL passes through the second polarizing member 62 or the second polarizing region 25c of the outside light polarizing member 25, and is emitted as the second polarized light P2, to be specific, the vertically polarized light. The external light OL that passes through the outside light polarizing member 25 passes the light-transmitting region A1 of the light-blocking member 21, passes through the light-transmitting region A2 of the scattering member 22, and passes through the light-transmitting region A3 of the pattern polarizing member 23. In this state, the external light OL is not subjected to a lens action due to the outside light polarizing member 25, the light-blocking member 21, the scattering member 22 and the pattern polarizing member 23. A general external image is observed by the eyes EY of the wearer US. In other words, an external image can be recognized in a see-through view via the first display optical system 103a.

Although detailed description is omitted, the image light ML solely for the left eye emitted from the second portion 104b is also observed in the same manner as the image light ML solely for the right eye emitted from the first portion 104a. That is, by the second display optical system 103b, an image formed at the scattering member 22 is observed as a virtual image at a desired magnification ratio behind the scattering member 22, and see-through viewing of an external image through the scattering member 22 is possible.

In the above description, in the pattern polarizing member 23, the first polarization member 61 transmits only the image light ML being the horizontally polarized light, and the second polarizing member 62 transmits the external light OL being the vertically polarized light. However, the first polarizing member 61 of the pattern polarizing member 23 may transmit the image light ML being the vertically polarized light, and the second polarizing member 62 of the outside light polarizing member 25 may transmit the external light OL being horizontally polarized light. With regard to the first polarization separation lens element 150a, it is necessary to change the polarization directions for the lens function accordingly as the function of the pattern polarizing member 23, or the like is changed.

With reference to FIG. 9A, the repetition section 22s may be regarded as a combination of an external light visual recognition pixel X1 being the light-transmitting region A2 and an image light emission pixel X2 being the sub-pixel PEa, and is also referred to as a see-through image display pixel TX. The see-through image display pixel TX may be regarded as a pixel that allows a background scene to be viewed in a see-through manner, from the viewpoint that the see-through image display pixel TX forms a pixel at a position where the external light OL is locally blocked. The external light OL that is not blocked by the light-blocking member 21 while the polarization direction thereof is restricted by the outside light polarizing member 25 passes through the light-transmitting region A2 being a part of the see-through image display pixel TX of the scattering member 22, passes through the light-transmitting region A2 of the pattern polarizing member 23, and passes through while maintaining a light beam state by the liquid crystal lens 51. Meanwhile, the polarization direction of the image light ML that is emitted from the scattering region 22e of the image display region 22p being a part of the see-through image display pixel TX is limited by the pattern polarizing member 23, and the image light ML passes through the liquid crystal lens 51 while being subjected to a light condensing action or a lens action, and is converted into a virtual image corresponding to display by the pixel display region 22p.

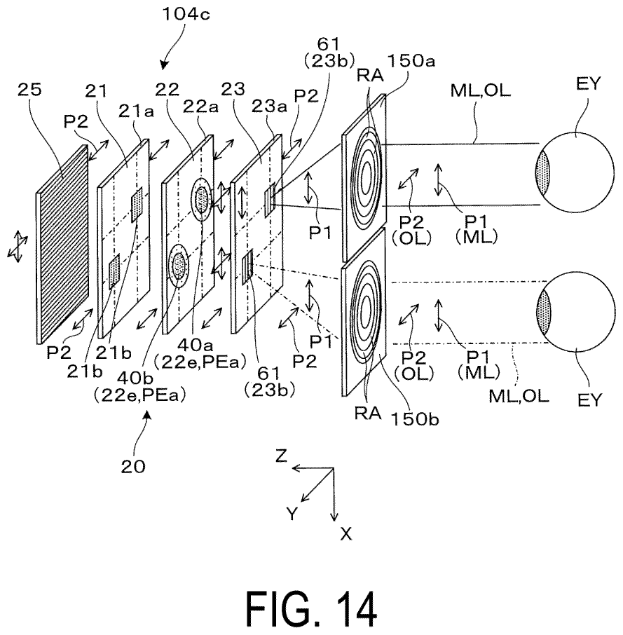

FIG. 14 describes a case where the image light ML for both the eyes emitted from the third portion 104c is observed. The image light ML emitted from the first scattering regions 40a on one side formed at the common scattering member 22 passes through the first polarizing member 61 or the first polarizing region 23b of the pattern polarizing member 23 to become the first polarized light P1 being the horizontally polarized light, and passes through the first polarization separation lens element 150a functioning as a convex lens with respect to the first polarized light P1 to form a virtual image with respect to the right eye. The image light ML emitted from the second scattering region 40b on another side formed at the common scattering member 22 passes through the first polarizing member 61 or the first polarizing region 23b of the pattern polarizing member 23 to become the first polarized light P1 being the horizontally polarized light, and passes through the second polarization separation lens element 150b functioning as a convex lens with respect to the first polarized light P1 to form a virtual image with respect to the left eye. Note that the external light OL that passes through the light-transmitting region A2 and the like of the scattering member 22 of the third portion 104c travels straight through the first polarization separation lens element 150a or the second polarization separation lens element 150b to enable see-through viewing of an external image.

In the above description, the image light ML emitted from the scattering member 22 is restricted to the horizontally polarized light in the first polarizing direction by the pattern polarizing member 23. However, when the scattering region 22e of the scattering member 22 can have selectivity in a scattering direction with respect to polarized light in a specific polarization direction, the scattering member 22 can also function as the pattern polarizing member 23, and the pattern polarizing member 23 can be omitted.

The head-mounted display apparatus 200 of the first embodiment described above includes: the scattering member 22 including the first scattering region 40a for scattering the image light ML for the right eye and the second scattering region 40b for scattering the image light ML for the left eye, the first projection optical system 10a configured to irradiate the first scattering region 40a with the image light ML, the second projection optical system 10b configured to irradiate the second scattering region 40b with the image light ML, the light-blocking member 21 arranged at the external side of the scattering member 22 and configured to suppress incidence of the external light OL on the first scattering region 40a and the second scattering region 40b, the first polarizing member 61 arranged at the face side of the scattering member 22 and including the first polarizing region 23b provided corresponding to the first scattering region 40a and the second scattering region 40b for restricting the image light ML scattered by the scattering member 22 to the first polarization direction, the second polarizing member 62 arranged at the external side of a position of the first polarizing member 61 and including the second polarizing region 25c for restricting the external light OL to the second polarization direction different from the first polarization direction, and the polarization separation lens elements 150a and 150b arranged at the face side of the first polarizing member 61 and having refractive power that selectively acts on polarized light of the image light ML.

In the head-mounted display apparatus 200 described above, transmitted light from an outside world that passes through the light-blocking member 21 passes through the second polarizing member 62, is restricted to the second polarization direction, and passes through the polarization separation lens element 150a or 150b without being subjected to an action of refractive power. On the other hand, the image light ML emitted from the first scattering region 40a and the second scattering region 40b passes through the first polarizing member 61, is restricted to the first polarization direction, and passes through the polarization separation lens elements 150a and 150b while being subjected to an action of refractive power to form a virtual image. In this case, a pair of virtual images corresponding to a pair of images formed in the scattering regions 40a and 40b of the scattering member 22 can be formed while the scattering member 22 and the polarization separation lens elements 150a and 150b are arranged near the eyes EY, and an angle of view can be increased without separating the scattering member 22 and the polarization separation lens elements 150a and 150b to a large degree. Further, by adjusting the arrangement of the first scattering region 40a and the second scattering region 40b, it is possible to display an image common to both the eyes EY.

### Second Embodiment

A head-mounted display apparatus of a second embodiment will be described below. Note that the head-mounted display apparatus of the second embodiment is obtained by partially modifying the head-mounted display apparatus of the first embodiment, and description of parts in common with those of the head-mounted display apparatus of the first embodiment is omitted.

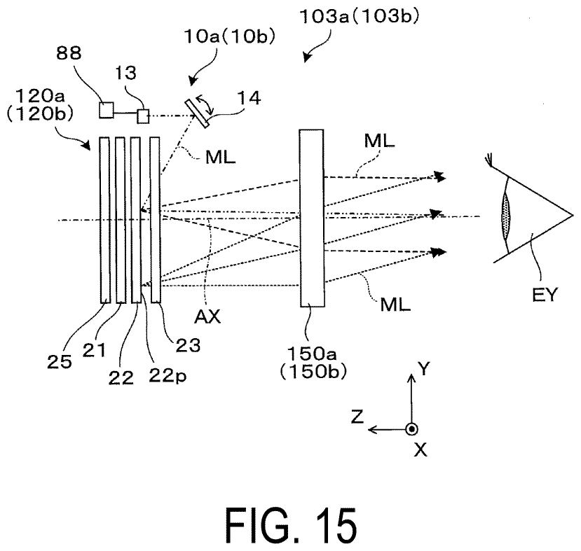

As illustrated in FIG. 15, the first projection optical system 10a includes a laser light source 13 and a micro mirror 14 or an MEMS mirror. The first projection optical system 10a projects modulated light from the laser light source 13 onto the pixel display region 22p of the scattering member 22 as the image light ML by the micro mirror 14 driven for scanning. In other words, a locus along which the modulated light moves on the scattering member 22 by the scanning corresponds to an image to be displayed. In the first projection optical system 10a, an angle of the image light ML emitted from the laser light source 13 is changed by the micro mirror 14 or the MEMS mirror, and the image light ML is emitted toward the composite display member 120a. The first projection optical system 10a projects the modulated light from the laser light source 13 onto the first scattering region 40a (see FIG. 8) as the image light ML by the micro mirror 14 driven for scanning.

Although detailed description will be omitted, the second projection optical system 10b also includes, similarly to the first projection optical system 10a, the laser light source 13 and the micro mirror 14, an angle of the image light ML from the laser light source 13 is changed by the micro mirror 14, and the image light ML is emitted toward the composite display member 120b. The second projection optical system 10b projects the modulated light from the laser light source 13 onto the second scattering region 40b (see FIG. 8) as the image light ML by the micro mirror 14 driven for scanning.

Note that the projection optical systems 10a and 10b according to the second embodiment can be used instead of the projection optical systems 10a and 10b according to the first embodiment also in the head-mounted display apparatus 200 and the like according to third and subsequent embodiments.

### Third Embodiment

A head-mounted display apparatus of a third embodiment will be described below. Note that the head-mounted display apparatus of the third embodiment is obtained by partially modifying the head-mounted display apparatus of the first embodiment, and description of parts in common with those of the head-mounted display apparatus of the first embodiment is omitted.

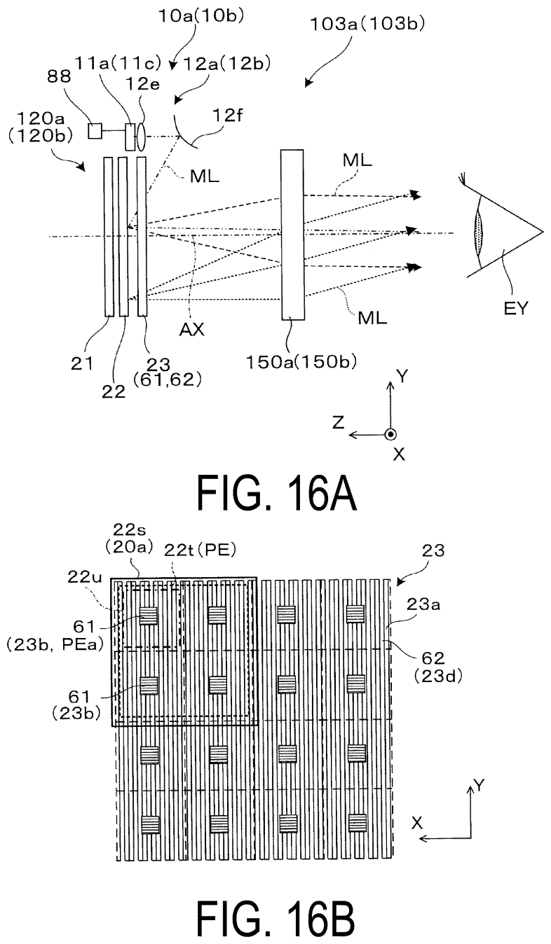

As illustrated in FIG. 16A, the pattern polarizing member 23 maybe obtained by integrally incorporating the first polarizing member 61 and the second polarizing member 62. In this case, the outside light polarizing member 25 is not provided.

That is, the first polarizing member 61 and the second polarizing member 62 are formed at the same substrate. The first polarizing members 61 or the first polarizing regions 23b are arrayed on lattice points as illustrated in the FIG. 16B, and the second polarizing member 62 or the second polarizing region 23d is arranged around the first polarizing member 61 or the first polarizing region 23b (a region corresponding to the light-transmitting region A3 illustrated in FIG. 6C). Accordingly, it is possible to divide the first polarizing region 23b and the second polarizing region 23d in a planar manner, and it is possible to reduce the number of components while suppressing interference between the image light ML and the external light OL. Note that the second polarizing member 62 or the second polarizing region 23b may be arranged slightly away from a position of the first polarizing member 61 or the first polarizing region 23b toward the face side as long as control of polarization is not affected. Also in this case, it is considered that the second polarizing member 62 is arranged on the external side from the position of the first polarizing member 61.

### Fourth Embodiment

A head-mounted display apparatus of a fourth embodiment will be described below. Note that the head-mounted display apparatus of the fourth embodiment is obtained by partially modifying the head-mounted display apparatus of the first embodiment, and description of parts in common with those of the head-mounted display apparatus of the first embodiment is omitted.

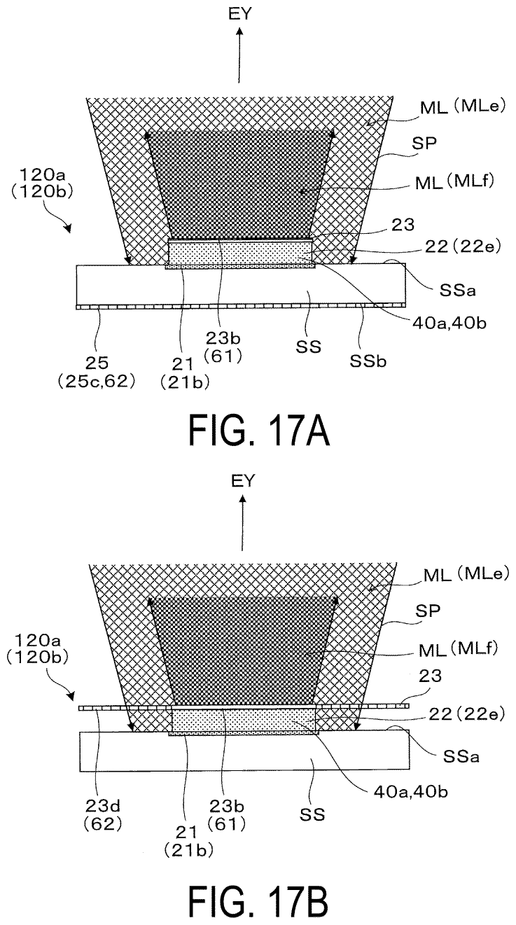

As illustrated in FIG. 17A, the members 25, 21, 22 and 23 of each of the composite display members 120a and 120b of the embodiment are integrated at the same substrate SS. Specifically, at a first surface SSa which is one main surface of the substrate SS, the light-blocking member 21, the scattering member 22 and the pattern polarizing member 23 are arranged in this order from the external side, and the outside light polarizing member 25 is arranged at a second surface SSb which is another main surface of the substrate SS. The members 21, 22, and 23 are structured by being in close contact with each other. Here, since the scattering member 22 is indirectly supported by the common substrate SS, the scattering member 22 is incorporated as the scattering region 22e or the scattering region 40a or 40b from which a supporting flat plate is omitted, and the pattern polarizing member 23 is incorporated as the first polarizing region 23b from which a supporting flat plate is omitted. By providing the scattering region 22e of the scattering member 22 at a front surface of the substrate SS, it is possible to suppress entry of scattered light into the substrate SS and to prevent occurrence of a ghost. In addition, by integrating the members 25, 21, 22 and 23, the device can be reduced in thickness and weight.

The substrate SS is made of glass or plastic that transmits light, for example. In the composite display member 120a or 120b, the light-blocking layer 21b is formed at the substrate SS by vapor deposition and etching, and the scattering region 22e is formed at the light-blocking layer 21b. The scattering region 22e is obtained by, for example, performing etching after spin coating to partially form a scattering structure.

The image light ML or the sub-pixel spot SP projected from the projection optical system 10a or 10b as projected light MLe is incident on the scattering region 22e of the scattering member 22 through the discretely formed first polarizing region 23b of the pattern polarizing member 23. Image light MLf incident on the scattering region 22e is scattered, passes through the first polarizing region 23b again, and horizontally polarized light in the first polarization direction is incident on the polarization separation lens element 150a or 150b.

Note that as illustrated in FIG. 17B, each member of the composite display member 120a or 120b may be arranged similarly as in the third embodiment. In this case, the light-blocking member 21, the scattering member 22 and the pattern polarizing member 23 of the composite display member 120a are formed at the first surface SSa on the face side of the substrate SS, and the pattern polarizing member 23 includes the first polarizing member 61 which is the first polarizing region 23b and the second polarizing member 62 which is the second polarizing region 23d. Note that the pattern polarizing member 23 maybe provided with a support (not illustrated).

### Fifth Embodiment

A head-mounted display apparatus of a fifth embodiment will be described below. Note that the head-mounted display apparatus of the fifth embodiment is obtained by partially modifying the head-mounted display apparatus of the first embodiment, and description of parts in common with those of the head-mounted display apparatus of the first embodiment is omitted.

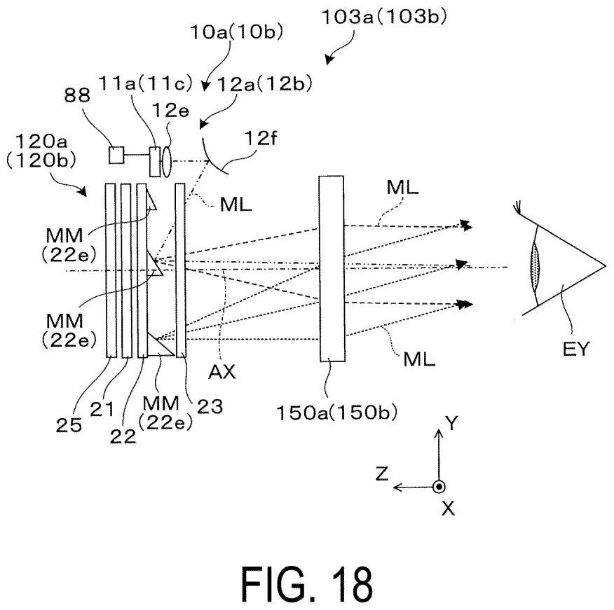

As illustrated in FIG. 18, in the embodiment, a micro mirror MM is provided in the scattering region 22e at the scattering member 22. The micro mirror MM is a member that guides the image light ML in a direction of the eye EY. An inclination angle of the micro mirror MM depends on positions of the pixel PE. The micro mirror MM may have a smooth surface or may have a scattering structure.

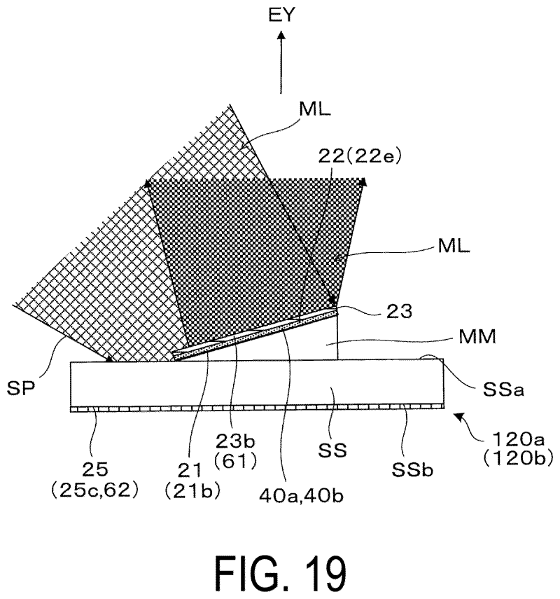

FIG. 19 illustrates a specific example of the composite display member 120a or 120b of the embodiment. The composite display member 120a or 120b illustrated in FIG. 19 has a structure similar to that of the composite display member 120a or 120b illustrated in FIG. 17A, in which the scattering member 22, the light-blocking member 21 and the pattern polarizing member 23 are formed at the first surface SSa on the face side of the substrate SS, and the outside light polarizing member 25 is formed at the second surface SSb on the external side of the substrate SS. In FIG. 19, the light-blocking layer 21b is formed at a front surface of the micro mirror MM which is a part of the scattering member 22, and the scattering member 22 or the scattering region 22e is provided thereat.

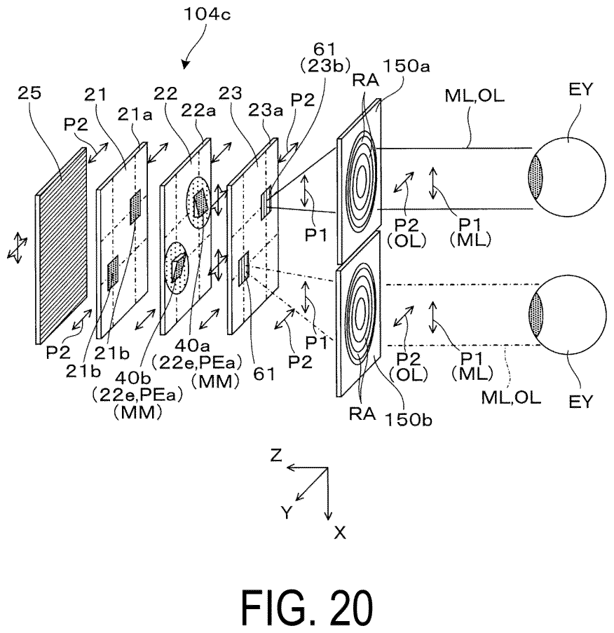

FIG. 20 describes a case where the image light ML for both the eyes emitted from the third portion 104c is observed. The first scattering region 40a on one side formed at the common scattering member 22 adjusts an emission angle toward the polarization separation lens element 150a in charge of the right eye by the micro mirror MM, and the second scattering region 40b on another side adjusts an emission angle toward the polarization separation lens element 150b in charge of the left eye by the micro mirror MM. The Image light ML emitted from the first scattering region 40a on the one side passes through the first polarizing member 61 or the first polarizing region 23b of the pattern polarizing member 23 to become the first polarized light P1 being the horizontally polarized light, and passes through the first polarization separation lens element 150a functioning as a convex lens with respect to the first polarized light P1 to form a virtual image with respect to the right eye. The image light ML emitted from the second scattering region 40b on the other side passes through the first polarizing member 61 or the first polarizing region 23b of the pattern polarizing member 23 to become the first polarized light P1 being the horizontally polarized light, and passes through the second polarization separation lens element 150b functioning as a convex lens with respect to the first polarized light P1 to form a virtual image with respect to the left eye. Note that the external light OL that passes through the light-transmitting region A2 and the like of the scattering member 22 of the third portion 104c travels straight through the first polarization separation lens element 150a or the second polarization separation lens element 150b to enable see-through viewing of an external image.

### Sixth Embodiment

A head-mounted display apparatus of a sixth embodiment will be described below. Note that the head-mounted display apparatus of the sixth embodiment is obtained by partially modifying the head-mounted display apparatus of the first embodiment, and description of parts in common with those of the head-mounted display apparatus of the first embodiment is omitted.

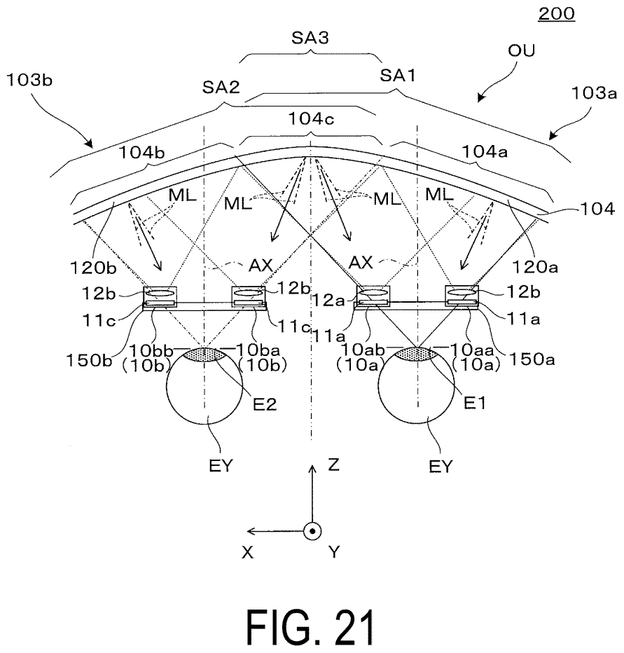

As illustrated in FIG. 21, the head-mounted display apparatus 200 of the embodiment includes a pair of projection optical systems 10aa and 10ab as the first projection optical system 10a, and includes a pair of projection optical systems 10ba and 10bb as the second projection optical system 10b. The pair of projection optical systems 10aa and 10ab each have a structure similar to that of the first projection optical system 10a, but take charge of different angle-of-view display regions, respectively, and have overlapping display regions overlapping each other. The pair of projection optical systems 10ba and 10bb each have a structure similar to that of the second projection optical system 10b, but take charge of different angle-of-view display regions, respectively, and have overlapping display regions overlapping each other.

As in the case of FIG. 2, in the common observation region SA3, the first scattering region (not illustrated) scatters the image light ML for the right eye incident from the projection optical system 10ab on a central right side so as to be reflected in an angular direction within a relatively narrow range toward the eye point E1 where the right eye exists, and the second scattering region (not illustrated) scatters the image light ML for the left eye incident from the projection optical system 10ba on a central left side so as to be reflected in an angular direction within a relatively narrow range toward the eye point E2 where the left eye exists. In the first observation region SA1, the image light ML for the right eye incident from the projection optical system 10aa at a right end is scattered so as to be reflected in a relatively narrow angle direction toward the eye point E1 where the right eye exists. In the second observation region SA2, the image light ML for the left eye incident from the projection optical system 10bb at a left end is scattered so as to be reflected in a relatively narrow angle direction toward the eye point E2 where the left eye exists.

The first observation region SA1 includes an overlapping region on which the image light ML from the pair of projection optical systems 10aa and 10ab is incident in an overlapping manner. Although not illustrated in the drawing, two types of scattering regions having different scattering characteristics are formed in a staggered manner in the overlapping region, and the image light ML from the projection optical systems 10aa and 10ab arranged at different positions is scattered so as to be reflected in an angular direction within a relatively narrow range toward the common eye point E1 where the right eye exists.

The second observation region SA2 includes an overlapping region on which the image light ML from the pair of projection optical systems 10ba and 10bb is incident in an overlapping manner. Although not illustrated in the drawing, two types of scattering regions having different scattering characteristics are formed in a staggered manner in the overlapping region, and the image light ML from the projection optical systems 10ba and 10bb arranged at different positions is scattered so as to be reflected in an angular direction within a relatively narrow range toward the common eye point E2 where the left eye exists.

### MODIFICATION EXAMPLES AND OTHERS

Although the present disclosure has been described with reference to the above-described embodiments, the present disclosure is not limited to the above-described embodiments and can be implemented in various modes without departing from the spirit of the disclosure. For example, the following modifications are possible.

In the embodiment described above, the liquid crystal lens 51 is not limited to one including the electrode as an element, and may be one having refractive power by filling a space between a Fresnel lens-like first substrate and a flat plate-like second substrate with liquid crystal and aligning the alignment of the liquid crystal with a Fresnel lens surface.

The liquid crystal lens 51 may include an elongated circular electrode that is slightly elongated in a specific direction, instead of a circular electrode.

The liquid crystal lens 51 as the polarization separation lens element 150a is not limited to a lens including the orbicular zone RA having a ring shape. As the polarization separation lens element 150a, various structures having a lens action with respect to specific polarized light may be adopted.

Although it has been assumed above that the HMD 200 is worn on the head and is used, the virtual image display devices 100A and 100B may also be used as a hand-held display that is not worn on the head and is to be looked into like binoculars. In other words, according to an aspect of the present disclosure, the head-mounted display also includes a hand-held display.

In the embodiment described above, the arrangement and size of the pixel PE or the sub-pixel PEa can be changed as appropriate so that a sufficient see-through region exists in one pixel.

In the above embodiment, a micro optical element such as a microlens may be provided on the face side of the pattern polarizing member 23.

A head-mounted display apparatus in a specific aspect includes: a scattering member including a first scattering region for scattering image light for a right eye and a second scattering region for scattering image light for a left eye, a first projection optical system configured to irradiate the first scattering region with the image light, a second projection optical system configured to irradiate the second scattering region with the image light, a light-blocking member arranged at an external side of the scattering member and configured to suppress incidence of external light on the first scattering region and the second scattering region, a first polarizing member arranged at a face side of the scattering member and including a first polarizing region provided corresponding to the first scattering region and the second scattering region for restricting the image light scattered by the scattering member to a first polarization direction, a second polarizing member arranged at an external side of a position of the first polarizing member and including a second polarizing region for restricting the external light to a second polarization direction different from the first polarization direction, and a polarization separation lens element arranged at a face side of the first polarizing member and having refractive power that selectively acts on polarized light of the image light.

In the head-mounted display apparatus described above, transmitted light from an outside world that passes through the light-blocking member passes through the second polarizing member, is restricted to the second polarization direction, and passes through the polarization separation lens element without being subjected to an action of refractive power. On the other hand, the image light emitted from the first scattering region and the second scattering region passes through the first polarizing member, is restricted to the first polarization direction, and passes through the polarization separation lens element while being subjected to an action of refractive power to form a virtual image. In this case, a pair of virtual images corresponding to a pair of images formed in the first scattering region and the second scattering region of the scattering member can be formed while the scattering member and the polarization separation lens element are arranged near an eye, and an angle of view can be increased without separating the scattering member and the polarization separation lens element to a large degree. Further, by adjusting the arrangement of the first scattering region and the second scattering region, it is possible to display an image common to both the eyes.

In a head-mounted display apparatus in a specific aspect, the scattering member includes the first scattering region, the second scattering region, and a light-transmitting region that enables visual recognition of an outside world.

In a head-mounted display apparatus in a specific aspect, the scattering member includes a first observation region for the right eye and a second observation region for the left eye that partially overlap each other, and the first scattering region and the second scattering region are arranged in a staggered manner in a common observation region where the first observation region and the second observation region overlap each other. By separating the polarization separation lens element from the scattering member sufficiently, an eye box can be easily enlarged. On the other hand, it is necessary to provide the common observation region for forming an image common to both the eyes in the scattering member. For this reason, since the first scattering region and the second scattering region are arranged in a staggered manner in the common observation region, it is easy to secure a visual field angle toward a direction of the eye on another side.

In a head-mounted display apparatus in a specific aspect, in the common observation region, the first scattering regions and the second scattering regions are each arranged in a square lattice shape or a rectangular lattice shape, and are arranged in a face-centered lattice shape as a whole. In this case, it becomes easy to ensure display balance of images for both the eyes while ensuring image quality when observing the common observation region.

In a head-mounted display apparatus in a specific aspect, the first scattering region and the second scattering region have an angle characteristic matching a line-of-sight direction. In this case, it is possible to efficiently emit the image light from the first scattering region toward a right eye position, and to efficiently emit the image light from the second scattering region toward a left eye position, and to prevent images for the left and right eyes from interfering with each other.

In a head-mounted display apparatus in a specific aspect, the first polarizing regions are discretely provided corresponding to the scattering regions.

In a head-mounted display apparatus in a specific aspect, the light-blocking member includes a light-blocking layer that suppresses incidence of the external light, and the light-blocking layer has a size corresponding to that of the first scattering region and the second scattering region. In this manner, incidence of the external light on the scattering region can be further suppressed.

In a head-mounted display apparatus in a specific aspect, the polarization separation lens element is a polarization separation liquid crystal lens that causes a plurality of pixels to collectively form an image. With an independent lens, an eye box can be enlarged.

In a head-mounted display apparatus in a specific aspect, the first projection optical system includes a first image display panel configured to display an image, and projects light emitted from a light-emitting region of the first image display panel onto the first scattering region as the image light, and the second projection optical system includes a second image display panel configured to display an image, and projects light emitted from a light-emitting region of the second image display panel onto the second scattering region as the image light. That is, an image on the first image display panel is projected onto the corresponding first scattering region, and an image to be displayed is formed on the first scattering member, an image on the second image display panel is projected onto the corresponding second scattering region, and an image to be displayed is formed on the second scattering member.

In a head-mounted display apparatus in a specific aspect, the first projection optical system projects modulated light from a laser light source onto the first scattering region as the image light, by a micro mirror driven for scanning, and the second projection optical system projects modulated light from the laser light source onto the second scattering region as the image light, by the micro mirror driven for scanning. In other words, a locus along which the modulated light emitted from the first projection optical system or the second projection optical system moves on the first scattering member or the second scattering member by the scanning corresponds to an image to be displayed.

In a head-mounted display apparatus in a specific aspect, the light-blocking member, the scattering member, and the first polarizing member are integrated. Accordingly, it is possible to reduce the device in thickness and weight.

In a head-mounted display apparatus in a specific aspect, the scattering member includes a scattering region for red, a scattering region for green, and a scattering region for blue, and includes a light-transmitting region that transmits the external light in a region where the scattering region is not arranged.

An optical unit in a specific aspect includes: a scattering member including a first scattering region for scattering image light for a right eye and a second scattering region for scattering image light for a left eye, a first projection optical system configured to irradiate the first scattering region with the image light, a second projection optical system configured to irradiate the second scattering region with the image light, a light-blocking member arranged at an external side of the scattering member and configured to suppress incidence of external light on the first scattering region and the second scattering region, a first polarizing member arranged at a face side of the scattering member and including a first polarizing region provided corresponding to the first scattering region and the second scattering region for restricting the image light scattered by the scattering member to a first polarization direction, a second polarizing member arranged at an external side of a position of the first polarizing member and including a second polarizing region for restricting the external light to a second polarization direction different from the first polarization direction, and a polarization separation lens element arranged at a face side of the first polarizing member and having refractive power that selectively acts on polarized light of the image light.

What is claimed is:

1. A head-mounted display apparatus comprising:
a scattering member including a first scattering region configured to scatter image light for a right eye and a second scattering region configured to scatter the image light for a left eye;
a first projection optical system configured to irradiate the first scattering region with the image light;
a second projection optical system configured to irradiate the second scattering region with the image light;
a light-blocking member arranged at an external side of the scattering member and configured to suppress incidence of external light on the first scattering region and the second scattering region;
a first polarizing member arranged at a face side of the scattering member and including a first polarizing region provided corresponding to the first scattering region and the second scattering region, the first polarizing region being configured to restrict the image light scattered by the scattering member to a first polarization direction;
a second polarizing member arranged at an external side of a position of the first polarizing member and including a second polarizing region configured to restrict the external light to a second polarization direction different from the first polarization direction; and
a polarization separation lens element arranged at a face side of the first polarizing member and having refractive power configured to selectively act on polarized light of the image light.

2. The head-mounted display apparatus according to claim 1, wherein
the scattering member includes the first scattering region, the second scattering region, and a light-transmitting region enabling visual recognition of an outside world.

3. The head-mounted display apparatus according to claim 1, wherein
the scattering member includes a first observation region for the right eye and a second observation region for the left eye, the first observation region and the second observation region partially overlapping each other, and
the first scattering region and the second scattering region are arranged in a staggered manner in a common observation region where the first observation region and the second observation region overlap each other.

4. The head-mounted display apparatus according to claim 3, wherein
in the common observation region, the first scattering regions and the second scattering regions are each arranged in a square lattice shape or a rectangular lattice shape, and are arranged in a face-centered lattice shape as a whole.

5. The head-mounted display apparatus according to claim 3, wherein
the first scattering region and the second scattering region have an angle characteristic matching a line-of-sight direction.

6. The head-mounted display apparatus according to claim 1, wherein
the first polarizing regions are discretely provided corresponding to the first scattering regions and the second scattering regions.

7. The head-mounted display apparatus according to claim 1, wherein
the light-blocking member includes a light-blocking layer configured to suppress incidence of the external light and
the light-blocking layer has a size corresponding to that of the first scattering region and the second scattering region.

8. The head-mounted display apparatus according to claim 1, wherein
the polarization separation lens element is a polarization separation liquid crystal lens configured to cause a plurality of pixels to collectively form an image.

9. The head-mounted display apparatus according to claim 1, wherein
the first projection optical system includes a first image display panel configured to display an image, and projects light emitted from a light-emitting region of the first image display panel onto the first scattering region as the image light and
the second projection optical system includes a second image display panel configured to display an image, and projects light emitted from a light-emitting region of the second image display panel onto the second scattering region as the image light.

10. The head-mounted display apparatus according to claim 1, wherein
the first projection optical system projects modulated light from a laser light source onto the first scattering region as the image light, by a micro mirror driven for scanning and
the second projection optical system projects the modulated light from the laser light source onto the second scattering region as the image light, by the micro mirror driven for scanning.

11. The head-mounted display apparatus according to claim 1, wherein
the light-blocking member, the scattering member, and the first polarizing member are integrated.

12. The head-mounted display apparatus according to claim 1, wherein
the scattering member includes a scattering region for red, a scattering region for green, and a scattering region for blue, and includes a light-transmitting region in a region where the scattering region is not arranged, the light-transmitting region being configured to transmit the external light.

13. An optical unit comprising:
a scattering member including a first scattering region configured to scatter image light for a right eye and a second scattering region configured to scatter the image light for a left eye;
a first projection optical system configured to irradiate the first scattering region with the image light;
a second projection optical system configured to irradiate the second scattering region with the image light;
a light-blocking member arranged at an external side of the scattering member and configured to suppress incidence of external light on the first scattering region and the second scattering region;
a first polarizing member arranged at a face side of the scattering member and including a first polarizing region provided corresponding to the first scattering region and the second scattering region, the first polarizing region being configured to restrict the image light scattered by the scattering member to a first polarization direction;
a second polarizing member arranged at an external side of a position of the first polarizing member and including a second polarizing region configured to restrict the external light to a second polarization direction different from the first polarization direction; and
a polarization separation lens element arranged at a face side of the first polarizing member and having refractive power configured to selectively act on polarized light of the image light.
